(19) United States
(12) Patent Application Publication
(10) Pub. No.: US 2021/0161103 A1
(43) Pub. Date: Jun. 3, 2021

(54) PET LEASH

(71) Applicant: Easy on Pets, Cincinnati, OH (US)

(72) Inventor: Bhargav Madabhushi Rajamannar, Cincinnati, OH (US)

(73) Assignee: Easy on Pets, Cincinnati, OH (US)

(21) Appl. No.: 17/106,489

(22) Filed: Nov. 30, 2020

Related U.S. Application Data
(60) Provisional application No. 62/941,909, filed on Nov. 29, 2019.

(51) Int. Cl. A01K 27/00; F16B 45/02

(52) U.S. Cl. CPC A01K 27/005; F16B 45/02

(57) ABSTRACT

A pet leash includes a handle member, a first spring mechanism having a first end configured to be connected to the handle member, a belt system having a first end configured to be connected to a second end of the first spring mechanism, a second spring mechanism having a first end configured to be connected to the first end of the belt system and the second end of the first spring mechanism, and a second end configured to be connected to a collar. The springs stretch in response to any movement from the pet away from the pet handler and reduce the force on the handler and the dog.

### FIELD

The aspects of the disclosed embodiments relate to an apparatus for running, leading, or walking a pet, such as a dog, specifically a dog leash. Specifically, the presently described apparatus can be used to walk or run with a dog and is held by the pet handler.

### BACKGROUND

Running or walking a dog with a dog leash is a common and socially required practice when out. A dog even if on a leash, is inherently prone to sudden running movements, which may come as a surprise to the dog or pet handler. These sudden movements from the dog, when on a standard leash can also be harmful to the pet handler, including the potential for severe injury from a fall, or dislocation of the shoulder, should the force of the dog be significant.

Alternative leashes on the market that partially address this problem are retractable leashes, meaning a thin rope is spooled into a plastic handle, and the handler has the ability to reel the dog back in case it wanders too far. These leashes typically allow a dog to go 15 to 25 feet away from the handler. These leashes while partly serving the purpose are however designed with the primary intent of giving the pet more freedom, as against any protection against sudden pressure to the pet handler, or any effect that prevents the dog from the attempt of wanting to sprint away further.

Thus, there is a need for a dog leash that addresses the issue of sudden pressure from a dog's attempt to run and creates a resistance to the force, that decreases the sudden pressure on the pet handler, thereby preventing falls and injuries. In addition, there is need for a dog leash that delivers a counter pressure on the dog thereby potentially encouraging the dog to curb its urge to sprint away. Accordingly, it would be desirable to provide an apparatus that addresses at least some of the problems described above.

### SUMMARY

The aspects of the disclosed embodiments are directed to a leash for an animal such as a dog. The aspects of the disclosed embodiments provide a leash that can absorb the sudden pressure that may be applied to the leash if the animal tugs or tries to run. This and other objectives are addressed by the subject matter of the independent claim. Further advantageous modifications can be found in the dependent claims.

According to a first aspect, the above and further objectives and advantages are obtained by a leash. In one embodiment, the leash is made from a ribbon or rope made of nylon/fabric attached to one or more plastic casing components containing springs which attaches to the dog collar and a belt system that goes around the waist/torso section of the dog.

In a possible implementation form, the ribbon/rope attaches to a handle to be held by the dog walker. The plastic casing that encloses the spring mechanism is to be used to prevent a reactionary force due to the dog suddenly lunging forward too far or too fast. The ribbon/rope and the plastic casing are attached with interlocking rings or hooks and loops.

In a possible implementation form, the original leash attaches to the dog collar, and the secondary connection is to be the first method to prevent the dog from suddenly lunging forward too far or too fast.

In a possible implementation form, the springs in the leash expand as the dog starts to move away from the handler, such that the handler has time to react to the dog's speed. The belt mechanism attached to the leash is attached to the spring mechanism such that if the dog does decide to run suddenly, the belt will pull on the dog itself, thus creating an effect of the handler pulling back, dissuading the dog from running forward. If the dog continues to persist and the spring mechanism closest to the dog is fully expanded, the leash has a second spring in the plain ribbon/rope section to allow more time for the dog handler to react.

In a possible implementation form, the hand grip for the handler will be a normal grip into which a palm can fit snugly. The hand grip will be made of a combination of plastic and rubber materials.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which like references indicate like elements and:

FIG. 1 is a side view of a dog being walked with a leash incorporating aspects of the disclosed embodiments. The blow-up bubble depicts the spring mechanisms of the leash.

FIG. 2 shows how the leash and the belt system are connected between the leash and the dog.

FIG. 3 is a schematic illustration of a leash incorporating aspects of the disclosed embodiments.

FIG. 4 is a schematic illustration of a handle mechanism for a leash incorporating aspects of the disclosed embodiments.

FIG. 5 is a schematic illustration of a first section of the leash shown in FIG. 3.

FIG. 6 is a schematic illustration of a second section for the leash shown in FIG. 3.

FIG. 7 is a schematic illustration of an exemplary spring mechanism for the leash incorporating aspects of the disclosed embodiments.

### DETAILED DESCRIPTION OF THE DISCLOSED EMBODIMENTS

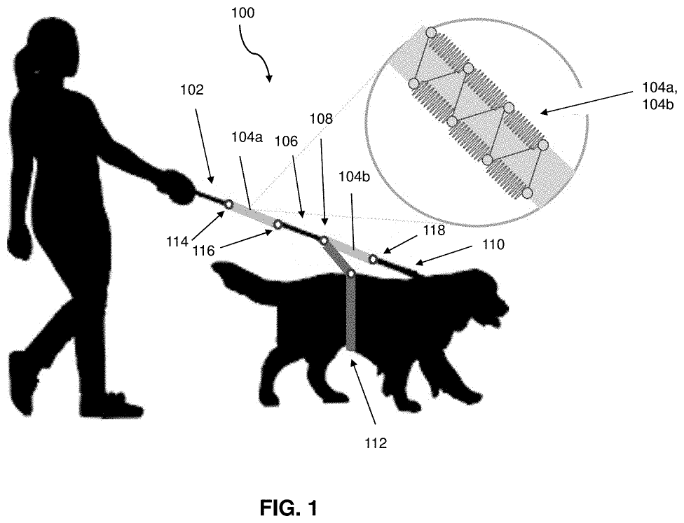

Referring to FIG. 1 a leash system or leash 100 incorporating aspects of the disclosed embodiments is illustrated. As shown in FIG. 1, the leash 100 comprises a handle member 102, a first or upper spring mechanism 104a, a connection member 108 to connect the leash 100 to a belt system 112, a second or lower spring member 104b and a connection member 110 to connect the leash 100 and the pet collar. The call-out illustrates aspects of the upper and lower spring mechanisms 104a, 104b. Although the example of FIG. 1 shows two spring mechanisms 104a, 104b, the aspects of the disclosed embodiments are not so limited. In alternate embodiments, the leash 100 can include any number of spring mechanisms other than including two. For example, the leash 100 could include only one spring mechanism or more than two spring mechanisms. The terms “upper” and “lower” when referring to the spring mechanisms 104a, 104b is merely for illustrative purposes.

In the example of FIG. 1, the handle member 102 is connected to the first spring member 104a with a connection member or ring assembly 114. Another connection member or ring assembly 116 connects the first spring member 104a with a leash member 106. The leash member 106 is configured to connect to the connection member 108. A further connection member or ring assembly 118 can be used to connect the spring mechanism 104b to the pet collar.

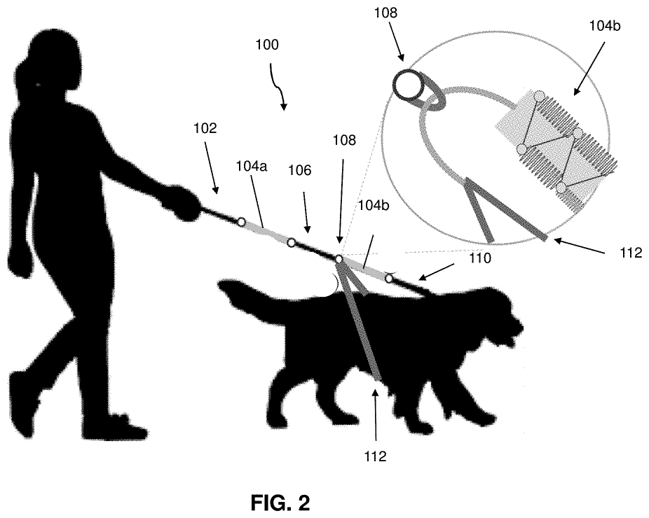

FIG. 2 illustrates another example of the leash 100 incorporating aspects of the disclosed embodiments. In this example, belt system 112 is in the form of an around the body belt 112 for the dog. The leash 100 includes or is connected to the around the body belt 112 for the dog. The call-out in FIG. 2 illustrates an exemplary connection member 108 that can be used to connect or couple the body belt 112 to the other components of the leash 100, as will be further described herein.

The leash of the disclosed embodiments is configured to absorb the forces that might be generated when the animal connected to the leash exerts a pulling force, rather than the handler having to directly counteract such pulling forces. The force that may be applied to the handler is reduced as is the force that might also be applied to the neck of the animal while pulling on the leash, for example. While the pet will be able to move away from the handler, the spring mechanisms 104a, 104b and the belt system 112 should attempt to dissuade the pet from such actions. When such a pulling force is applied, there will be an application of resistance or counterforce from the spring mechanisms 104a and 104b embedded within the leash 100.

For example, in one embodiment where a dog is connected to the leash, as the dog pulls away from the pet handler, the spring mechanism 104b will first expand and also apply a resisting force to the around the body belt 112. Once the spring mechanism 104b is fully expanded, the other spring mechanism 104a will start expanding, thus preventing an immediate pressure or force from being transferred to the pet handler. The force applied to the handler will be reduced and the handler will also have more time to react, before both the spring mechanisms 104a and 104b are fully expanded. Thus, in the event the pet pulls on the leash 100, the leash 100 of the disclosed embodiments prevents harm to both the pet and the pet handler such that the pet will not be choked by the leash and the handler will not fall forward or sustain an injury to the shoulder.

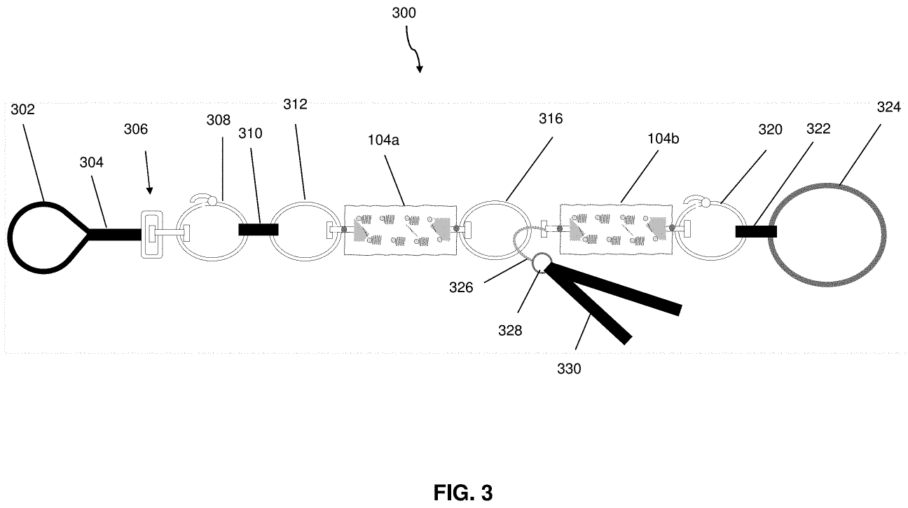

FIG. 3 illustrates an example of an exemplary leash assembly 300 incorporating aspects of the disclosed embodiments. In this example, the leash assembly includes a leash handle member 302 on one end and a pet collar 324 on the other end. Disposed in-between the handle member 302 and the collar 324 is a first spring mechanism 104a and a second spring mechanism 104b.

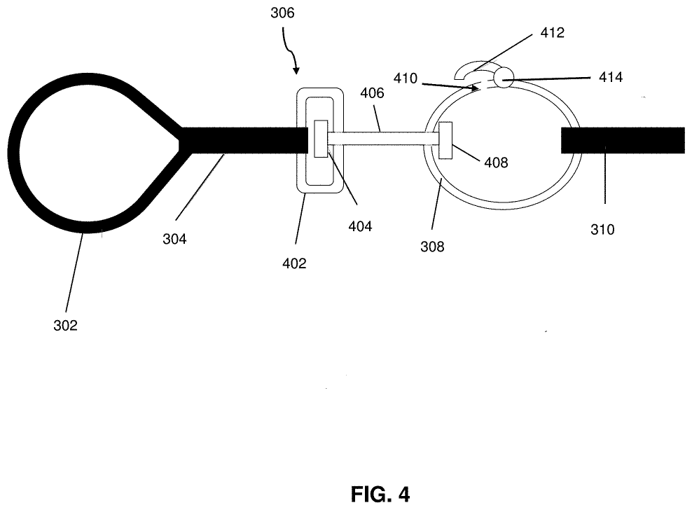

Referring also to FIG. 4, in one embodiment, the handle member 302 is in the form of a loop and is attached to a belt member 304. In one embodiment, the handle 302 and belt member 304 is made of a leather material. In alternate embodiments any suitable material or fabric can be used other than including leather. In one embodiment, the belt member 304 is looped through the connection member 306 and sewed in place.

The belt member 304 connects to the rest of the leash 100 via the connection member 306, also referred to as ring and bolt assembly 306. The ring and bolt assembly 306 includes a metal ring 402 and bolt mechanism 406. The metal ring 402 includes a hole or opening to allow the bolt 406 to be inserted into and retained therein by end member 404. The bolt 406 enables the ring 402 to be connected to another ring assembly or member 308.

In the example of FIG. 4, the other ring 308 includes a suitable opening that allows the bolt 406 to pass through and then be retained therein by end member 408. The ring and bolt assembly 306 is configured to enable the bolt 406 to rotate or swivel in conjunction with the movements of the leash 100.

Referring also to FIG. 4, in one embodiment, the ring 308 has an opening or gap 410 which through an end of the belt member 310 can be looped and retained. The belt member 310, which can be leather or such other suitable fabric, is used to connect the leash handle portion 102 to the rest of the components of the leash 100.

The gap 410 shown in FIG. 4 is configured to be closed by a latch 412, which is connected to the ring 308 via a rivet 414. Closing the latch 412 closes the gap 410 and secures the ring 308. This prevents the belt member 310 from coming off.

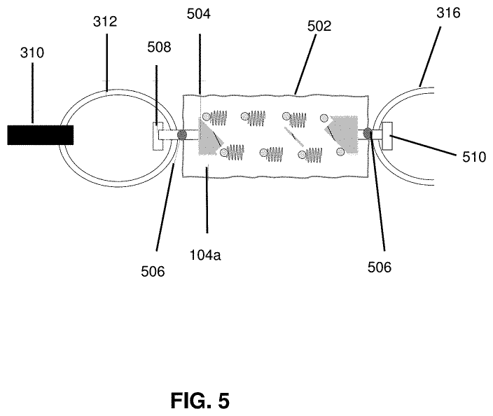

Referring also to FIG. 5, an example of the attachment of the spring mechanism 104a is illustrated. In this example, the spring mechanism 104a is disposed within a stretchable fabric casing 502. A rod or bolt member 504 is also secured to or within the stretchable fabric casing 502. In one embodiment, rivets 506 can be used to secure the bolt member 504 to the fabric casing 502. The bolt 504 is also connected to the ring 312. The ring 312 can include a corresponding opening that is configured to receive the bolt 504 and secure the bolt 504 to the ring 312 via the end member 508. The bolt 504 allows some rotation or swivelling of the ring 312. The ring 312 connects to the previous sections of the leash 100 and ring member 308 via the belt member 310.

The spring mechanism 104a connects to the next section of the leash 100 via a metal ring 316. The ring 316 includes an opening that is configured to receive and secure the rod or bolt 504. End member 510 is configured to secure the bolt member 504 to the ring member 316 is a rotatable fashion, similar to the other bolt and ring member connections described herein.

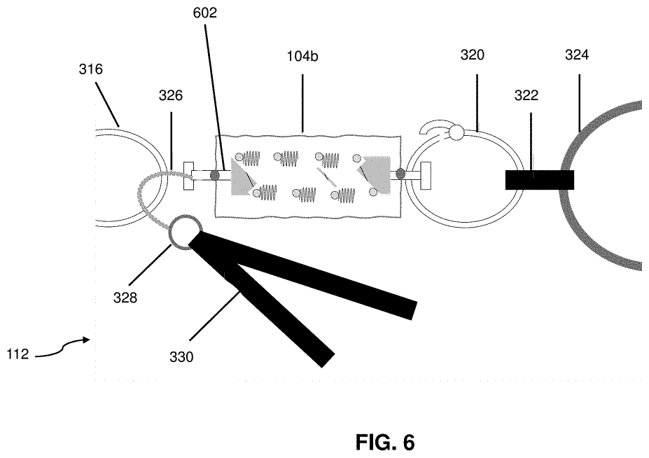

Referring to FIG. 6, lower portion of the leash 300 is illustrated that includes the other spring mechanism 104b. As shown in FIG. 6, the spring mechanism 104b is attached to the upper sections of the leash 300 via the ring 316. The spring mechanism 104b is similar to spring mechanism 104a described above.

With reference also to FIG. 1, the spring mechanism 104b is connected to a belt section 112 that is configured to go around the animal. The spring mechanism 104b and the belt section 112 are coupled or connected to each other and to the rest of the leash 100 via the ring 316. A small connection section 326 made of plastic or rubber material may be used to connect one end of the spring mechanism 104b to the belt section 112. The spring mechanism 104b then connects to the dog collar 324 via another ring 320 and belt section 322. The ring 320 is similar to the ring 308 described above with respect to FIG. 4. The ring 320 can also include a gap and latch member to secure the belt member 322 to the ring 320. In this example, one end of bolt member 602 is connected to the connection section 326, and the other end of bolt member 602 is connected to the ring member 320, in a similar manner as earlier described.

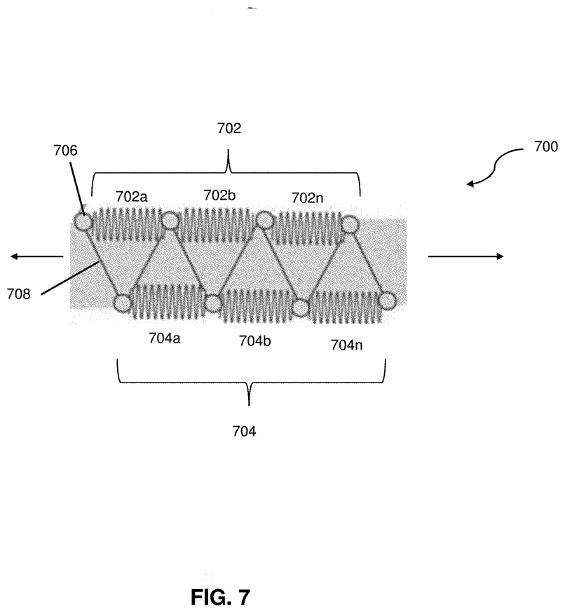

Referring to FIG. 7, one example of a spring mechanism 700 incorporating aspects of the disclosed embodiments is illustrated. The spring mechanism 700 incorporates the features of spring mechanisms 104a, 104b described herein. As shown in FIG. 7, the spring mechanism 700 comprises multiple sets of spring members 702, 704, such as metal springs, that are built so that they expand in sections in a cascaded manner. A set 702a, 704a of springs is connected to a next set 702b, 74b via rings 706 and rods 708. The sets 702, 704 can include any suitable number of springs 702n, 704n, to provide the desired or required amount of force and resistance. In one embodiment, the spring mechanism 700 is configured to be removable and re-insertable into a desired section of the leash 100. In this manner, additional spring mechanisms 700 can be added to the spring mechanisms 104a, 104b, or removed from the leash 100.

The aspects of the disclosed embodiments are directed to a leash made from normal rope or other material such as leather, with housing sections containing springs which attach to the dog collar and a belt system that goes around the waist/torso section of the dog. The original leash attaches to the dog collar, and the secondary connection is to be the first method to prevent the dog from suddenly lunging forward too far or too fast.

The springs in the leash expand slowly as the dog starts to move away from the handler, such that the handler has time to react to the dog's speed. The belt mechanism attached to the leash is positioned such that if the dog does decide to run suddenly, the belt will pull on the dog as if the handler is pulling back, dissuading the dog from running forward. If the dog continues to persist, the leash has a second spring to allow more time for the handler to react. The hand grip for the handler can be either the normal grip or the same plastic structure of the retractable leash.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pet leash comprising:
a handle member;
a first spring mechanism having a first end configured to be connected to the handle member;
a belt system having a first end configured to be connected to a second end of the first spring mechanism;
a second spring mechanism having a first end configured to be connected to the first end of the belt system and the second end of the first spring mechanism, and a second end configured to be connected to a collar.

2. The pet leash according to claim 1, wherein the first end of the belt system comprises:
a ring member that is configured to be connected to a fabric member of the belt system; and
a connection member connected to the ring member, wherein one end of the connection member is connected to the first end of the second spring mechanism.

3. The pet leash according to claim 2, further comprising a rod member extending through the first spring mechanism, one end of the rod member connected to a first ring member at the second end of the first spring mechanism, the first ring member rotatably connecting the second spring mechanism to the first spring mechanism, wherein the connection member of the belt system passes through the first ring member connected to the second end of the first spring mechanism.

4. The pet leash according to claim 3, further comprising a second ring member connected to the first end of the first spring mechanism, the second ring member configured to rotatably connect the first spring mechanism to the handle member.

5. The pet leash according to claim 4, wherein the handle member comprises:
a looped section;
a belt member with one end connected to the looped section;
a ring and bolt assembly, a second end of the belt member connected to the ring and bolt assembly;
a third ring member, the third ring member being rotatably connected to the ring and bolt assembly; and
a belt member connecting the third ring member to the second ring member.

6. The pet leash according to claim 5, further comprising a fourth ring member rotatably connected between a second end of the second spring mechanism and a collar.

7. The pet leash according to claim 1, wherein the first spring mechanism comprises:
a first set of spring members and a second set of spring members disposed in a spaced apart parallel alignment;
a first rod member connecting a first end of a first spring member of the first set to a first end of a first spring member of the second set; and
a second rod member connecting the first end of the first spring member of the second set to a second end of the first spring member of the first set; and
a third rod member connecting the second end of the first spring member of the first set to the second end of the first spring member of the second set.

8. The pet leash according to claim 7, further comprising a stretchable fabric casing, the first spring mechanism being disposed in the stretchable fabric casing.

9. The pet leash according to claim 1, wherein the second spring mechanism comprises:
a first set of spring members and a second set of spring members disposed in a spaced apart parallel alignment;
a first rod member connecting a first end of a first spring member of the first set to a first end of a first spring member of the second set; and
a second rod member connecting the first end of the first spring member of the second set to a second end of the first spring member of the first set; and
a third rod member connecting the second end of the first spring member of the first set to the second end of the first spring member of the second set.

10. The pet leash according to claim 9, further comprising a stretchable fabric casing, the second spring mechanism being disposed in the stretchable fabric casing.

11. A pet leash comprising:
a first section, the first section comprising a handle member connected to a first spring mechanism;
a second section, the second section comprising a collar member, a belt system and a second spring mechanism connected between the collar member and the belt system; and
a rotatable connection member connecting the first section of the leash and the second section of the leash.

12. The pet leash according to claim 11, wherein the first section further comprises a ring assembly connected between the handle member and the first spring mechanism, the ring assembly configured to enable the handle member to rotate relative to the first spring mechanism.

13. The pet leash according to claim 12 further comprising:
a ring member that is configured to be connected to a fabric member of the belt system; and
a connection member connected to the ring member, wherein one end of the connection member is connected to a first end of the second spring mechanism and looped through the rotatable connection member connecting the first section of the leash and the second section of the leash.

14. The pet leash according to claim 13 further comprising a rod member extending through a stretchable fabric casing of the first spring mechanism, one end of the rod member connected to the rotatable connection member connecting the first section of the leash and the second section of the leash and a second end of the rod member connected to the ring assembly of the first section.

15. The pet leash according to claim 14 further comprising a rod member extending through a stretchable fabric casing of the second spring mechanism, one end of the rod member connected to the connection member and a second end of the rod member connected to a ring assembly of the second section of the leash.

16. The pet leash according to claim 15 wherein the first spring mechanism comprises:
a first set of spring members and a second set of spring members disposed in a spaced apart parallel alignment;
a first rod member connecting a first end of a first spring member of the first set to a first end of a first spring member of the second set; and
a second rod member connecting the first end of the first spring member of the second set to a second end of the first spring member of the first set; and
a third rod member connecting the second end of the first spring member of the first set to the second end of the first spring member of the second set.

17. The pet leash according to claim 16, wherein the second spring mechanism comprises:
a first set of spring members and a second set of spring members disposed in a spaced apart parallel alignment;
a first rod member connecting a first end of a first spring member of the first set to a first end of a first spring member of the second set; and
a second rod member connecting the first end of the first spring member of the second set to a second end of the first spring member of the first set; and
a third rod member connecting the second end of the first spring member of the first set to the second end of the first spring member of the second set.
